(19) United States
(12) Patent Application Publication
(10) Pub. No.: US 2016/0314185 A1
(43) Pub. Date: Oct. 27, 2016

(54) IDENTIFYING EVENTS FROM AGGREGATED DEVICE SENSED PHYSICAL DATA

(71) Applicant: Microsoft Technology Licensing, LLC, Redmond, WA (US)

(72) Inventors: Susan Imogene Buchanan, Dallas, TX (US); Wayne Brian Miller, Keller, TX (US); Sunil Nambiar, Irving, TX (US)

(21) Appl. No.: 14/697,429

(22) Filed: Apr. 27, 2015

(51) Int. Cl. G06F 17/30

(52) U.S. Cl. CPC G06F 17/30598; G06F 17/3053

(57) ABSTRACT

Aspects extend to methods, systems, and computer program products for predicting events from aggregated device sensed physical data. Aspects facilitate dynamically targeted collection and aggregation of physical metrics (e.g., body metrics and environmental metrics) from varying sensing devices. Aggregated data can be used for pattern analysis, reporting and predictive results on health related events (or other scenarios). Collected physical metric data can be anonymized or personalized based at least in part on data source. Pattern analysis can be used to report at different levels (e.g., personal or commercial, localized or global) and return relevant contextual driven results, including potential healthcare related events or other events relating to the study of changes that occur in large groups of people over a period of time (e.g., relating to demography).

### CROSS-REFERENCE TO RELATED APPLICATIONS

Not Applicable

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments. For example, distributed applications can have components at a number of different computer systems.

Body metric data (e.g., temperature) used to detect health related events can be self-reported and/or can be collected by various different types of electronic devices. However, any detection primarily relies on retrospective analysis of collected body metrics. Retrospective analysis does not effectively integrate near real-time data collection from multiple data sources. Retrospective analysis also fails to make timely use of contextual information, such as, location and time.

Further, individuals that self-report often wait some amount of time (hours, days, or weeks) before reporting. The lack of immediacy means that information is potentially out of date by the time it is received.

As such, current mechanisms for reporting and analyzing body metric data are typically relegated to detecting previously occurring health related events.

Additionally, collecting body metric data from multiple data sources can produce large amounts of diversely formatted body metric data and omit relevant contextual clues. The body metric data may be difficult to quickly comprehend and visualize as natively formatted. It may also be difficult to derive any meaningful determinations based on the body metric data and present those determinations meaningfully to a user.

### BRIEF SUMMARY

Examples extend to methods, systems, and computer program products for identifying events from aggregated device sensed physical data. A computer system is communicatively coupled to a database of physical metric data. The database stores values for one or more physical metrics including one or more of: body metrics, behavioral metrics and environmental metrics. The physical metric data stored in a plurality of database entries, each entry including a value for a physical metric, geo-spatial data, temporal data, and a device identifier.

The device identifier identifies a device that collected the value for the physical metric. The physical metric data is related to a plurality of individuals and is collected using one or more corresponding devices (e.g., sensors) configured to sense one or more different physical metrics. The physical metric data is automatically collected from the one or more corresponding devices in accordance with specified timing.

A health related event or end state is identified from the physical metric data. The computer system accesses a request for a health related determination. The computer system identifies a sub-plurality of database entries, from among the plurality of entry database entries, as relevant to the request. Each of the sub-plurality of entry database entries is identified as relevant based on one or more of: the physical metric data, the geo-spatial data, the temporal data, and the device identifier included in the database entry.

The computer system aggregates values included in sub-plurality of database entries in into an aggregated data set in accordance with the request. The computer system analyzes the aggregated data set to identify a health related event. The computer system indicates the identified health related event in response to the request. Identifying a health related event can include detecting a previous or ongoing health related event or predicting a health related event that may occur in the future.

Additional features and advantages will be set forth in the description which follows, and in part will be obvious from the description, or may be learned by practice. The features and advantages may be realized and obtained by means of the instruments and combinations particularly pointed out in the appended claims. These and other features will become more fully apparent from the following description and appended claims, or may be learned by the practice as set forth hereinafter.

### BRIEF DESCRIPTION OF THE DRAWINGS

In order to describe the manner in which the above-recited and other advantages and features can be obtained, a more particular description of the aspects briefly described above will be rendered by reference to specific implementations thereof which are illustrated in the appended drawings. Understanding that these drawings depict only some implementations and are not therefore to be considered to be limiting of scope, the implementations will be described and explained with additional specificity and detail through the use of the accompanying drawings in which:

FIG. 1 illustrates an example computer architecture for identifying health related events from aggregated device sensed physical data.

FIG. 2 illustrates a flow chart of an example method for identifying a health related event.

FIG. 3 illustrates an example Devices Access Control Number (DACN) format.

FIG. 4 illustrates an example computer architecture for identifying health related events from device sensed physical data.

FIG. 5 illustrates an example computer architecture for identifying health related events from device sensed physical data.

FIG. 6 illustrates an example aggregation model.

FIG. 7 illustrates an example table of market segments and usage types.

### DETAILED DESCRIPTION

Examples extend to methods, systems, and computer program products for identifying events from aggregated device sensed physical data. A computer system is communicatively coupled to a database of physical metric data. The database stores values for one or more physical metrics including one or more of: body metrics, behavioral metrics and environmental metrics. The physical metric data stored in a plurality of database entries, each entry including a value for a physical metric, geo-spatial data, temporal data, and a device identifier.

The device identifier identifies a device that collected the value for the physical metric. The physical metric data is related to a plurality of individuals and is collected using one or more corresponding devices (e.g., sensors) configured to sense one or more different physical metrics. The physical metric data is automatically collected from the one or more corresponding devices in accordance with specified timing.

A health related event or endpoint is identified from the physical metric data. The computer system accesses a request for a health related determination. The computer system identifies a sub-plurality of database entries, from among the plurality of entry database entries, as relevant to the request. Each of the sub-plurality of entry database entries is identified as relevant based on one or more of: the physical metric data, the geo-spatial data, the temporal data, and the device identifier included in the database entry.

The computer system aggregates values included in sub-plurality of database entries in into an aggregated data set in accordance with the request. The computer system analyzes the aggregated data set to identify a health related event. The computer system indicates the identified health related event in response to the request. Identifying a health related event can include detecting a previous or ongoing health related event or predicting a health related event that may occur in the future.

Implementations may comprise or utilize a special purpose or general-purpose computer including computer hardware, such as, for example, one or more processors and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the various described aspects can be practiced in network computing environments with many types of computer system configurations, including, personal computers, desktop computers, laptop computers, message processors, hand-held devices, wearable devices, multi-processor systems, microprocessor-based or programmable consumer electronics, network PCs, minicomputers, mainframe computers, mobile telephones, PDAs, tablets, pagers, watches, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

In this description and the following claims, a “sensing device” is defined as a device that senses a physical metric. A sensing device can be a more specialized device, such as, for example, a thermometer, an anemometer, etc. or a more generalized device, such as, for example, a smart phone or computer. A sensing device may be configurable to sense different physical metrics by physical or digitally (e.g., through software) changing settings, alerting configurations, etc. of the sensing device. Sensing devices can include scanners, Infrared (IR) cameras, embedded devices, wearable devices, implantable devices, smart sensors, Radio Frequency Identification (RFID) devices, silicone membrane technologies, etc.

In this description and the following claims, “physical metrics” are defined as metrics that can be sensed by a sensing device. Physical metrics can include body metrics and environment metrics. A body metric is a metric of a human body, such as, for example, age approximation, body size, approximated Body Mass Index (BMI), height, weight, temperature, biometrics, bodily fluids (DNA, blood, urine, feces, mucous, phlegm, snot, earwax) chemical(s) and their metabolites (including pH), blood glucose, blood pressure, anticoagulation levels, bone density, skin resistance, breathing and respiration (e.g., oxygen saturation, pattern and frequency, CO₂ level, breath odor), heart rate (including patterns), imaging (X-ray, MRI, Ultrasound), visual body metrics (e.g., iris recognition, retina recognition, ear (features and shape), facial (features and patterns, including recognition), fingerprint recognition, hand (including finger nail bed) geometry and recognition, foot (toe nail bed) geometry recognition, vascular patterns), auditory (speech patterns, speech recognition, speaker identification), behavioral (walking style or gait, walking speed, keystroke dynamics, signature), fine motor, force touch (keystroke dynamics and signature recognition) and psychological measurements etc. An environmental metric is a metric of an environment, such as, for example, population, weather, movements of individuals, pollen count, ambient temperature, air pressure, altitude, Ultra Violet (UV) exposure, etc.

In this description and the following claims, a “health related event” is defined as an event related to the health and/or safety of one or more individuals. A health related event can be an environmental event or condition, such as, for example, an earthquake, severe weather (e.g., a tornado), etc. A health related event (or endpoint) can be a public health event, such as, for example, an epidemic or pandemic. A health related event can be detection of a condition (physical, behavioral, etc.) within one or more individuals, such as, for example, symptoms, signs, lab abnormalities, disease, etc.

Aspects facilitate dynamically targeted collection and aggregation of physical metrics (e.g., body metrics and environmental metrics) from varying sensing devices. Aggregated data can be used for pattern analysis, identification, reporting and predictive results on health related events (or other scenarios). Identification, pattern analysis, reporting and predictive results can be performed on hundreds, thousands, millions, or even billions of physical metric values, wherein the physical metric values are collected from hundreds, thousands, or even millions of sensing devices. Sensing devices can be in different geographic locations. Sensing devices can collect and report values for physical metrics as specified by users and administrators. Identification, pattern analysis, reporting and predictive results can be tailored for specific market segments.

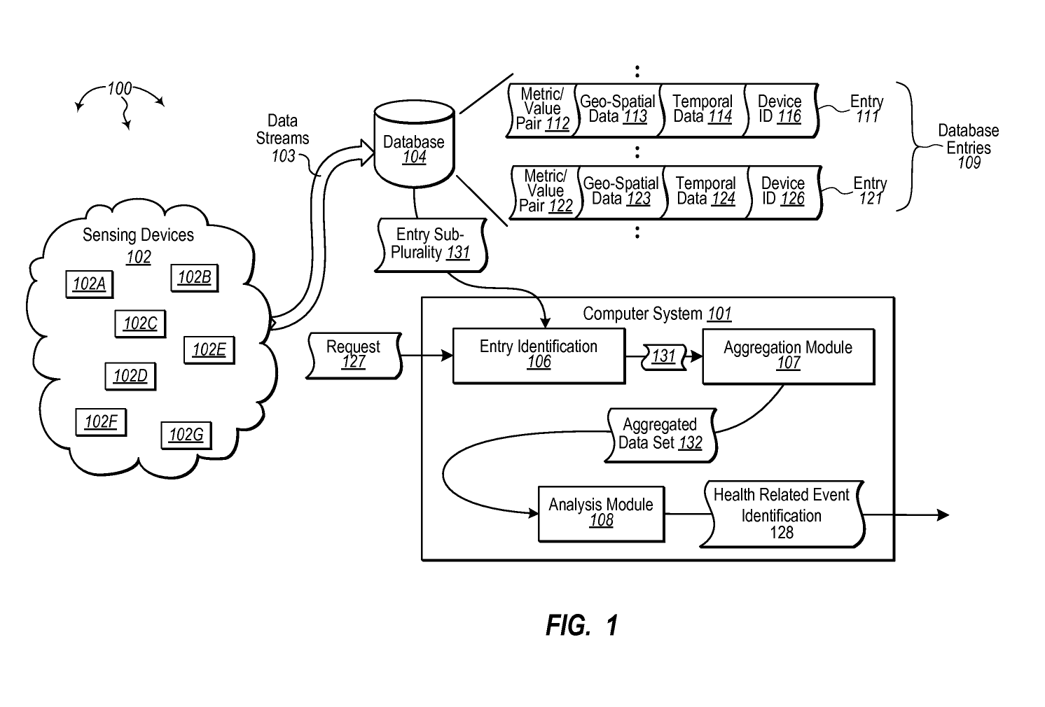

FIG. 1 illustrates an example computer architecture 100 for identifying health related events from device sensed physical data. Referring to FIG. 1, computer architecture 100 includes computer system 101, sensing devices 102, and database 104. Computer system 101, sensing devices 102, and database 104 can be connected to (or be part of) a network, such as, for example, a Local Area Network (“LAN”), a Wide Area Network (“WAN”), and even the Internet. Accordingly, computer system 101, sensing devices 102, and database 104 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

As depicted, sensing devices 102 includes sensing devices 102A-102G. Any (potentially large) number of other sensing devices can also be included in the sensing devices 102. Sensing devices 102 can be distributed across different geographic locations, used by different entities, and configured to sense one or more of a variety of different physical metrics. For example, sensing devices can vary from a thermometer in a hospital, to a thermal imaging camera in an airport, to a fitness band being worn by an individual.

Different sensing devices may be configured to monitor the same physical metric with varying degrees of accuracy (fidelity). For example, thermometer can measure an absolute temperature for an individual. A thermal imaging camera can measure temperature differentials between individuals in a group with a specified margin of error. The thermometer may have a smaller margin of error relative to the thermal imaging camera when measuring temperature.

Different sensing devices of the same type can also have different margins for error. For example, a thermometer from one manufacturer may be more or less accurate than a thermometer from another different manufacturer.

Sensing devices 102 can include some sensing devices that are similar to (or even the same as) one another, such as, for example, multiple IR cameras and can also include some sensing devices that are different from one another, such as, for example, a thermometer and an anemometer. Thus, some sensing devices can be capable of sensing similar (or even the same) physical metrics while other sensing devices are capable of sensing different physical metrics relative to one another. As such, each different sensing device included in sensing devices 102 can be capable of sensing and reporting data for one or more physical metrics. The one or more physical metrics can be the same as or different from other sensing devices included in sensing devices 102.

Sensing devices may be individually configured (either locally and/or remotely depending on the sensing device) to sense and report data for any physical metrics within their capabilities in accordance with user or administrator instructions. For example, embedded sensing devices in public areas might be individually configured to sense designated physical metrics when requested, on a specified schedule, at specified intervals, in response to communication from another device (which may also be a sensing device), or upon user specified approval for privately owned devices.

Each different sensing device included in sensing devices 102 can also be configured to send a data stream of one or more sensed physical metrics to database 104 in accordance with user or administrator instructions. For example, each different sensing device can be individually configured to send a data stream of sensed physical metrics, when requested, on a specified schedule, at specified intervals, when a threshold at the sensing device is satisfied, or upon user specified approved for privately owned devices, etc.

In some aspects, a sensing device includes a storage device. The sensing device can sense values for a physical metric on an ongoing basis and store an indication of the sensed values at the storage device. When a number of sensed values satisfy a threshold, the sensing device can send a data stream of the sensed values from the storage device to database 104. For example, a camera or IR scanner can sense temperature differentials at the entrance to a public place (e.g., a library or school). As long as temperature differentials for scanned individuals are within specified (normal) ranges, the camera or IR scanner may send a data stream of values for temperature at specified intervals (e.g., hourly or daily). However, if temperature differentials exceed specified normal ranges (either in differential or number of individuals with elevated temperatures), the camera or IR scanner may send a data stream of values for temperature prior to the next specified interval.

A data stream from a sensing device can include one or more values for a sensed physical metric, geo-spatial data for the one or more values, temporal data for the one or more values, and a device ID. Depending on configuration, a data stream for a sensing device can push data to database 104 in near real-time or essentially in real-time.

Geo-spatial data for a sensed physical metric value can specify a geographic location where the sensing device sensed the value for the physical metric. Geo-spatial data vary in fidelity from more precise, such as, Global Positioning System (GPS) Coordinates or an address, to less precise, such as, zip code or city. In one aspect, geo-spatial data specifies a building or campus, such as, for example, an airport, a high school, a university, a hospital, a restaurant, a store, etc.

Temporal data for a sensed physical metric value can indicate the time and date when the sensing device sensed the value for a physical metric value. Temporal data can also vary in fidelity from more precise, such as, millisecond accuracy, to less precise, such as, minute or hour accuracy, to even less precise, such as, day accuracy.

Individual data streams can be formatted in accordance with a storage schema used by database 104 (e.g., an eXtensible Markup Language (XML) schema). The storage schema defines semantics and structure for body metric data to facilitate more efficient exchange of body metric data between database 104 and other devices and databases. A schema can define a format for sensed values, geo-spatial data, temporal data, and a device ID.

A device ID identifies the sensing device. In one aspect, a device ID is a Device Access Control Number (DACN). The DACN includes manufacturer, product and version, usage type, and a unique identifier for a sensing device. A DACN can include extra unused fields for storing additional and/or expanded sensing device information, such as, for example, user specific information, and additional device information available in the future, etc.

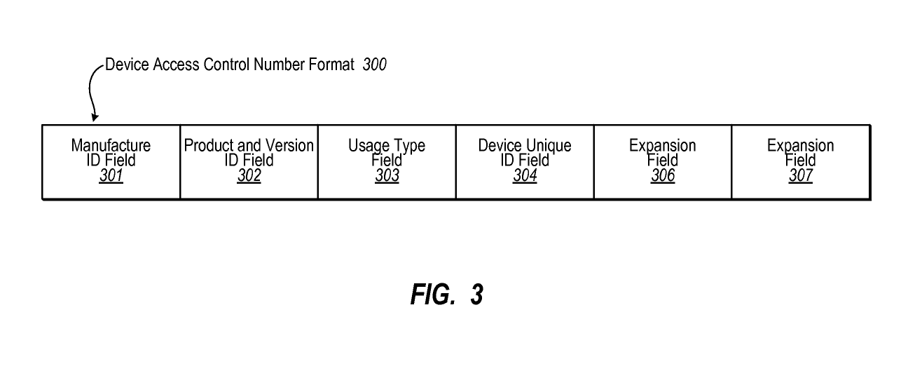

Turning briefly to FIG. 3, FIG. 3 illustrates Devices Access Control Number (DACN) format 300. As depicted, DACN format 300 includes manufacturer ID field 301, product and version ID field 302, usage type field 303, device unique ID field 304, expansion field 306, and expansion field 307. Data stored in device IDs in data entries 109, including device IDs 116 and 126, can be of DACN format 300 or a similar format.

Individual data streams from sensing devices included in sensing devices 102 are collectively represented by data streams 103.

Database 104 can store data from data streams 103 as database entries. Each database entry can include a metric/value pair, geo-spatial data, temporal data, and a device ID. The metric value pair indicates a physical metric and a sensed value for the physical metric (e.g., human body temperature and 98.6 degrees Fahrenheit). The geo-spatial data indicates a location where the sensed value was sensed. The temporal data indicates a date and time when the sensed value was sensed. The device ID identifies the sensing device that sensed the sensed value.

For example, database 104 includes database entries 109. Database entries 109 can include hundreds, thousands, or even millions of database entries representing sensed physical metrics. As depicted, database entries 109 include entries 111 and 121. The vertical ellipses before, between, and after entries 111 and 121 represent that hundreds, thousands, million, or billions of database entries can be included in database 104 before, after, and between entries 111 and 121.

Entry 111 includes metric/value pair 112, geo-spatial data 113, temporal data 114, and device ID 116. Device ID 116 can identify sensing device 102A, including the manufacturer of sensing device 102A, a product and version of sensing device 102A, a usage type of sensing device 102A and a unique identifier for sensing device 102A. Metric/value pair 112 can indicate a physical metric and a value sensing device 102A sensed for the physical metric (e.g., heartrate and 65 beats per minute). Geo-spatial data 113 can indicate a location (e.g., GPS coordinates, a building or campus, an address, a zip code, etc.) where sensing device 102A sensed metric/value pair 112. Temporal data 114 can indicate a date and time when sensing device 102A sensed metric/value pair 112.

Likewise, entry 121 includes metric/value pair 122, geo-spatial data 123, temporal data 124, and device ID 126. Device ID 126 can identify sensing device 102E, including the manufacturer of sensing device 102E, a product and version of sensing device 102E, a usage type of sensing device 102E and a unique identifier for sensing device 102E. Metric/value pair 122 can indicate a physical metric and a value sensing device 102E sensed for the physical metric (e.g., blood sugar (glucose) level and 125 mg/dL). Geo-spatial data 123 can indicate a location (e.g., GPS coordinates, a building or campus, an address, a zip code, etc.) where sensing device 102E sensed metric/value pair 122. Temporal data 124 can indicate a date and time when sensing device 102E sensed metric/value pair 122.

In general, computer system 101 can identify health related events from database entries 109. Entry identification module 106 can identify a sub-plurality of entries from database entries 109 that are relevant to a health related event. Aggregation module 107 can aggregate values from the sub-plurality of entries into an aggregated data set. Analysis module 108 can analyze the aggregated data set to identify a health related event. An identified health related event can be indicated to relevant entities and/or personnel. Identifying a health related event can include detecting a previous or ongoing health related event or predicting a health related event that may occur in the future.

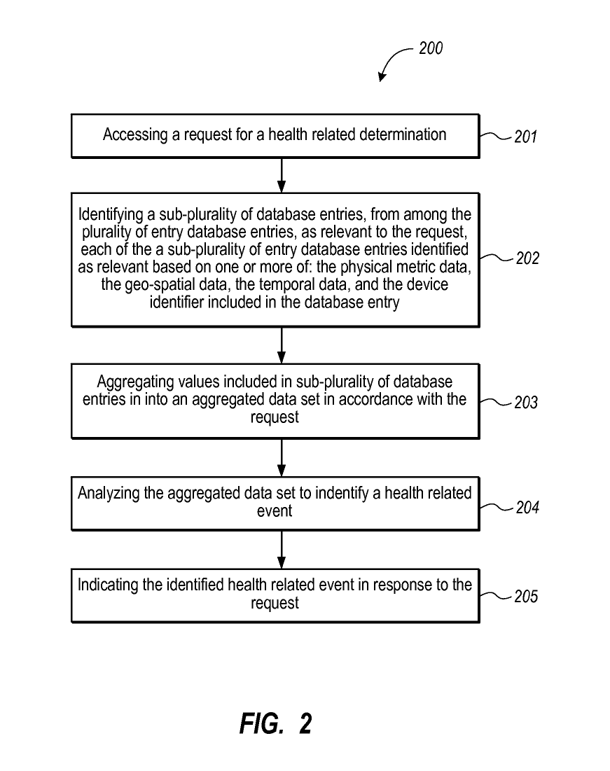

FIG. 2 illustrates a flow chart of an example method 200 for identifying a health related event. Method 200 will be described with respect to the components and data of computer architecture 100.

Method 200 includes accessing a request for a health related determination (201). For example, computer system 101 can access request 127. Request 127 can be a manually or automatically submit request for a health related determination. Request 127 can be an ad hoc request or a request that is intermittently submitted on an ongoing basis.

Method 200 includes identifying a sub-plurality of database entries, from among the plurality of entry database entries, as relevant to the request, each of the a sub-plurality of entry database entries identified as relevant based on one or more of: the physical metric data, the geo-spatial data, the temporal data, and the device identifier included in the database entry (202). For example, entry identification module 106 can identify entry sub-plurality 131 (from database entries 109) as relevant to request 127. Entry sub-plurality 131 can include entries for body metrics and/or environmental metrics. Computer system 101 can communicate with database 104 using a Web service to identify and retrieve entry sub-plurality 131.

A relevancy algorithm (heuristic) can determine relevancy of a database entry to a health related determination request based on one or more of: data contained in the database entry, a location associated with the health related determination request, a time period associated with the health related determination request, a device accuracy indicated in the health related determination request, etc. For example, temperature values sensed for individuals at or near an airport within the last eight hours may be relevant to a request to determine the possibility of a communicable disease outbreak at the airport.

In some aspects, physical metric values sensed in one location and/or at one time are relevant to a health related determination at another location and/or another time. For example, continuing with the airport example, a temperature of 103 degrees Fahrenheit sensed for an individual one day (e.g., at a home or doctor's office) may be relevant to the health related determination at the airport when the individual is travelling through the airport the next day. Various different tracking mechanisms can be used to link physical metric values sensed for an individual with the individual as the individual moves to different locations at different times. For example, fitness band or mobile phone identifiers can be associated with an individual and used to match physical metric values sensed for the individual in different locations and/or at different times with one another and with the individual. Tracking can be anonymous such that physical metric values for an individual can be linked to one another and to the individual but no identifying information about the individual is known.

In one aspect, a request is for physical metric values sensed at sensing devices with accuracy satisfying a specified threshold. Continuing with the airport example, values for temperature sensed by a thermometer may be relevant to request 127 but values for temperature differential sensed by a thermal imaging camera may not be relevant to request 127.

Method 200 includes aggregating values included in sub-plurality of database entries in into an aggregated data set in accordance with the request (203). For example, aggregation module 107 can aggregate values in entry sub-plurality 131 into aggregated data set 136. An aggregation algorithm (heuristic) can aggregate physical metric values (e.g., for both body metrics and/or environmental metrics) based on geo-spatial data, temporal data, and device characteristics associated with the physical metric values. For example, physical metric values sensed at devices with increased accuracy can be given more (e.g., statistical) weight relative to physical metric values sensed at devices with reduced accuracy. Similarly, physical metric values can be weighted (e.g., statistically) based on geo-spatial data and/or temporal data indicating more or less closeness to a location and/or time specified in a health related determination request respectively.

Method 200 includes analyzing the aggregated data set to identify a health related event (204). For example, analysis module 108 can analyze aggregated data set 132 to generate health related event identification prediction 128. An analysis algorithm (heuristic) can identify a health related event for one or more individuals or a health related event occurring at a location. For example, the analysis algorithm can identify that a communicable disease is spreading through a public location.

Method 200 includes indicating the identified health related event in response to the request (205). For example, computer system 101 can indicate health related event identification 128 in response to request 127. An identified health related event can be indicated to a relevant individual or authority. For example, a possible disease outbreak can be indicated to a relevant government entity.

In some aspects, an identified health related event can be rendered at a Graphical User Interface (GUI). The identified health related event can be rendered in a visual arrangement with other supporting and/or otherwise relevant data and content (e.g., some or all of the sub-plurality of database entries and/or aggregated values, locations, times and dates, representative user-interface elements and/or controls, etc). The rendered visual arrangement can present a health related event along with the other supporting and/or otherwise relevant data and content to a viewing individual.

When a health related event is identified, the health related event along with other relevant and/or representative data can be sent to a rendering module (not shown). The rendering module can render the health related event along with the other relevant and/or representative data and content in a visual arrangement of content at a user interface (e.g., a Graphical User Interface (GUI)). Accordingly, the user interface visually and meaningfully conveys circumstances of a health related event for a corpus physical metric data.

Supporting and/or otherwise relevant data can include a device used to sense a physical metric and the device's accuracy with respect to sensing the physical metric. Devices having decreased accuracy (e.g., IR cameras) can initially be used to identify a health related event (e.g., multiple individuals with increased temperature relative to surrounding individuals). The health related event can later be confirmed based on additional physical metric data from others devices (e.g., thermometers) with increased accuracy. As such, device types and device accuracies can be included along with a health related event in a visual arrangement of content rendered at a user interface. Device types and device accuracies can provide a viewing user with a degree of confidence in the health related event.

A GUI can be used to present health related events and other relevant and/or representative data and content for a single individual or for a plurality of individuals. In one aspect, a user consents to submission of their own physical metric data in exchange for the ability to review and track their own metrics and/or to be individually alerted of a potential health related event.

Time lapse, maps, and/or other techniques can be used to show status (e.g., progression) of an ongoing health related event over time (e.g., possible spread of a disease, etc.). As additional real time or near real time physical metric data associated with a health related event is accessed, the real time or near real time physical metric data can be integrated into a rendered visual arrangement of content at a user interface to visually update the status of the health related event within the user interface.

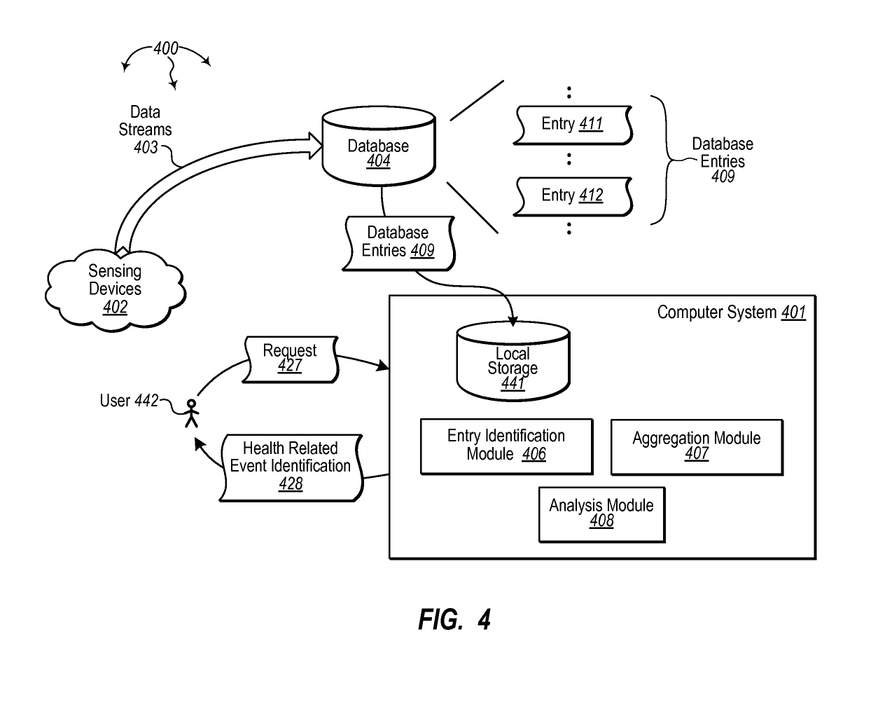

Turning to FIG. 4, FIG. 4 illustrates an example computer architecture 400 for identifying health related events from device sensed physical data. Referring to FIG. 4, computer architecture 400 includes computer system 401, sensing devices 402, and database 404. Computer system 401, sensing devices 402, and database 404 can be connected to (or be part of) a network, such as, for example, a Local Area Network (“LAN”), a Wide Area Network (“WAN”), and even the Internet. Accordingly, computer system 401, sensing devices 402, and database 404 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Any (potentially large) number of other sensing devices can be included in the sensing devices 402. Similar to sensing devices 102, sensing devices 402 can be distributed across different geographic locations, used by different entities, and configured to sense one or more of a variety of different physical metrics. Different sensing devices may be configured to monitor the same physical metric with varying degrees of accuracy (fidelity). Each different sensing device included in sensing devices 402 can be individually configured to sense designated physical metrics in accordance with user or administrator instructions. Similar to sensing devices 102, each different sensing device included in sensing devices 402 can also be configured to send a data stream of one or more sensed physical metrics to database 404 in accordance with user or administrator instructions.

A data stream from a sensing device in sensing devices 402 can include one or more values for a sensed physical metric, geo-spatial data for the one or more values, temporal data for the one or more values, and a device ID. Depending on configuration, a data stream for a sensing device can push data to database 404 in near real-time or essentially in real-time. Geo-spatial data for a sensed physical metric value can specify a geographic location where the sensing device sensed the value for the physical metric. Temporal data for a sensed physical metric value can indicate the time and date when the sensing device sensed the value for a physical metric value. A device ID identifies the sensing device and can be a Device Access Control Number (DACN).

Individual data streams from sensing devices included in sensing devices 402 are collectively represented by data streams 403.

Similar to database 104, database 404 can store data from data streams 403 as database entries. Each database entry can include a metric/value pair, geo-spatial data, temporal data, and a device ID. The metric value pair indicates a physical metric and a sensed value for the physical metric (e.g., a value related to a heart's electrical activity). The geo-spatial data indicates a location where the sensed value was sensed. The temporal data indicates a date and time when the sensed value was sensed. The device ID identifies the sensing device that sensed the sensed value.

Database entries 409 can include hundreds, thousands, millions, or even billions of database entries representing sensed physical metrics. As depicted, database entries 409 include entries 411 and 412. The vertical ellipses before, between, and after entries 411 and 412 represent that hundreds, thousands, or millions of database entries can be included in database 404 before, after, and between entries 411 and 412.

Entries 411 and 412 can contain data formatted similarly to entries 111 and 121 in FIG. 1 respectively.

An owner of computer system 401 may have on ongoing need to analyze database entries 409. Thus, the owner can purchase or otherwise obtain rights to database entries 409 from the owner of database 404. As such, database entries 409 can be transferred from database 404 to local storage 441.

In general, computer system 401 can identifying health related events from database entries 409. Entry identification module 406 can identify a sub-plurality of entries from database entries 409 (stored in local storage 441) that are relevant to a health related event. Aggregation module 407 can aggregate values from the sub-plurality of entries into an aggregated data set. Analysis module 408 can analyze the aggregated data set to identify a health related event. An identified health related event can be indicated to relevant entities and/or personnel.

For example, user 442 (e.g., an employee of the owner of computer system 401) can submit request 427 to computer system 401. Entry identification module 406, aggregation module 407, and analysis module 408 can interoperate to generate health related event identification 428 in response to request 427. Computer system 401 can return health related event identification 428 back to user 442.

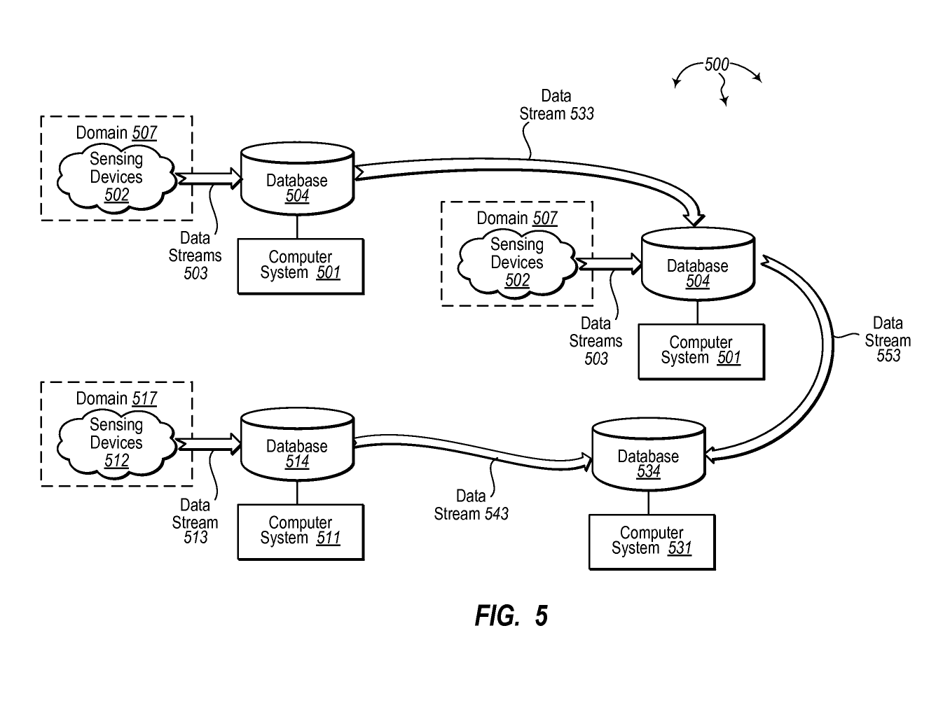

Turning to FIG. 5, FIG. 5 illustrates an example computer architecture 500 for identifying health related events from device sensed physical data. As depicted, sensing devices 502 sense values for physical metrics for domain 507, sensing devices 512 sense values for physical metrics for domain 517, and sensing devices 522 sense values for physical metrics for domain 527. Sensing devices 502 can send data streams 503 for storage in database 504, sensing devices 512 can send data streams 513 for storage in database 514, and sensing devices 522 can send data streams 523 for storage in database 524.

Computer system 501 can process entries from database 504 to identify health related events for domain 507. Similarly, computer system 511 can process entries from database 514 to identify health related events for domain 517.

Domain 507 may be a sub-domain of domain 527. For example, domain 527 can represent a county and domain 507 a city within the country. As such, database 504 can send data stream 533 to database 524. Data stream 533 can include data entries from database 504 having relevance to domain 527. Domain 527 can also have other sub-domains that stream relevant database entries to database 524. Database 524 can aggregate database entries from database 504 and form databases in other sub-domains together with database entries generated from data streams 523. Computer system 521 can process entries from database 524 to identify health related events for domain 527. Health related events for domain 527 can also be relevant to domain 507 and other sub-domains of domain 527.

Database 534 can be a further (e.g., state or national) repository. As such, database 514 can send data stream 543 to database 534. Data stream 543 can include data entries from database 514. Similarly, database 524 can send data stream 553 to database 534. Data stream 553 can include data entries from database 524. Database 534 can aggregate database entries from database 514 and database entries from database 524 together. Computer system 531 can process entries from database 534 to identify health related events for any of domain 507, domain 517, and domain 527.

The sensing devices, databases, and computer systems of computer architecture 500 can be connected to (or be part of) a network, such as, for example, a Local Area Network (“LAN”), a Wide Area Network (“WAN”), and even the Internet. Accordingly, the sensing devices, databases, and computer systems of computer architecture 500 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Database entries can be aggregated between databases in accordance with an aggregation model. The aggregation module can include multiple sensing devices serving as data points with a DACN based on device manufacture and user type (e.g., consumer, medical military, etc.). Device data points provide data to a local collector that can roll into zone collectors. Sensing devices can also be location aware for granularity for notifications, reporting, etc. performed via analysis and machine learning. An alternate dual methodology can facilitate aggregation based on a collection methodology using location (e.g., by Media Access Control (MAC) type of usage as well as location or more granular).

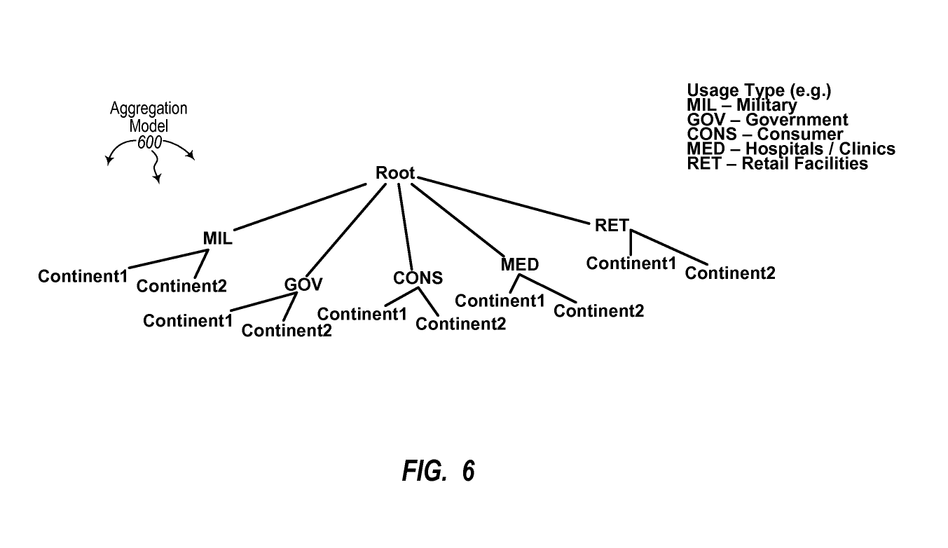

FIG. 6 illustrates an example aggregation model 600. On a per continent basis, one or more sensing devices can provide (stream) sensed physical metric data values to one or more local collectors corresponding to a zone connector (e.g., military, government, consumer, medical, and retail). The one or more local connectors can roll sensed physical metric data into the corresponding zone collector. For example, on continent 1, one or more local collectors for the military zone can roll sensed physical data values to the military zone collector. Zone collectors can correspondingly roll sensed physical metric data to root.

Different aggregation models can be used based on continuous connect devices streaming or non-streaming/non-continuous use data collection. Different aggregation models can also be used for anonymize data or personalized data.

For continuous scanning devices (e.g. IR Camera Scanner) devices, some devices may include a mathematical function which sends a result from a sensing device or group of sensing devices to evaluate (e.g., an Camera/IR scanner at a high school—the number of individuals scanned on entrance and that show elevated or higher temperature differentials). Sensed physical metric values can be aggregated within the sensing device until a threshold is satisfied. When the threshold is satisfied, sensed physical metric values can be sent to a corresponding database (e.g., using a web service via a mathematical heuristic).

For non-continuous use sensing devices or multi-user sensing devices (e.g., hand-held wireless thermometer, or Kiosk camera/scanner), a user may pair the sensing device (e.g., by scanning a code on the sensing device) with a health or wellness account identifying user being scanned. Alternately, with anonymization, the sensing devices send a DACN and location information to a zone level collector.

Various different data collection points can be used in different locations. Mass scanning can be used in a variety of environments. For example, airport security scanners can be scan for temperature differentials and body metrics for pattern prediction and interdiction. That is, notification of appropriate government officials when someone arrives with a fever.

Prison IR scanners can screen for higher heart rate to determine agitation levels of populations.

In schools and other public venues, scanners can screen individuals for illness and/or behavior identification. Scanning results can be used to detect outbreaks of disease or identify other health related events.

In retail venues, scanners can screen for body metrics (e.g., fever) to determine need for increased facilities maintenance.

In manufacturing venues, scanners can screen for body metrics (e.g., fever) for early prediction of illness that might impact staffing.

In medical facilities (hospital, dentist, etc.), scanners can screen to identify possible infections so that appropriate protocols can be used to prevent entry of a visitor who might infect at risk patients.

In a theater venue, scanners can screen to determine audience engagement and/or reactions to a play or movie.

Values for multiple biometric indicators can be combined to detect abnormal levels of a compound, or specific systems in a larger population. Appropriate authorities can be alerted. For example, values for multiple biometric indicators can be used for early detection of: malfunctioned water treatment facility, industrial accident/spill, chemical/biological attack, food contamination. Reviewing geo-spatial history, authorities may be able to track back to a likely source, such as, for example, people that ate at a particular restaurant, people that live in the same subdivision, people that work in the same office complex, etc.

For example, in airports continuous real-time or near real-time streaming can be provided by sensing devices, such as, IR cameras, scanners at entrance exits, millimeter wave scanner at entrance to secure area, and passenger fitness bands. In schools, continuous real-time or near real-time streaming can be provided by sensing devices IR scanners on entrance and Kinects. In schools, non-streaming/non-continuous data be provided by handheld devices (phones, tablets, etc.), smart sensors, smart band aids, and other smart devices. In medical facilities (hospitals, clinics, nursing homes, etc), continuous real-time or near real-time streaming can be provided by IR cameras/scanner on visitor entrance. In medical facilities, non-streaming/non-continuous data be provided by handheld devices (e.g., laser or wireless thermometers). In medical facilities, continuous Data Points can be provided by smart sensors, body bugs, microchips, implantables, wearable devices, and other silicone membrane technologies to track pH levels and temperature to provide routine updates and alerts to staff.

Aspects enable a variety of aggregation and health event identification scenarios. For example, upon entering a Hospital's emergency room real-time or near real-time scanning via the IR cameras is occurring. Individuals are scanned en masse for temperature differentials between them and other people around them. A scanner alerts an ER Triage nurse that an incoming patient has an extremely elevated body metric (temperature, or heart rate) thus allowing for a more immediate response time by staff. Likewise users Opting—in using a personal device (e.g., Band and health account) could alert the ER on arrival for check on their current body metrics.

In another example, upon entering a stadium or other venue security cameras perform real-time or near real-time scanning Individuals can be scanned en masse for temperature differentials relative to other individuals. Data sources (scanners) can send anonymous (non-identifying) data (e.g., temperature and other body metric values) along with geo-spatial and temporal data to a database. The real-time or near real-time data is processed to return relevant contextual results to individuals (users) who opt in to receive reporting results. The real-time or near real-time data can also be aggregated at larger (e.g., regional) level to report to other institutions and commercial organizations (hospitals, schools, pharmaceutical manufacturers, etc.).

In a further example, an international traveler is wearing a fitness band and has a health account with a health account provider. In preparation for an international flight, the traveler logs in to their health account to check personal health data and obtain any health alerts for the destination. Physical metric values for the traveler are anonymized and provided to a database.

Upon arrival at the destination, security cameras perform real-time or near real-time scanning. On exiting the plane, individuals can be scanned en masse for temperature differentials relative to other individuals. Data sources (scanners) can send anonymous (non-identifying) data (e.g., temperature and other body metric values) along with geo-spatial and temporal data to a database. The real-time or near real-time data is processed to return relevant contextual results to individuals (users) who opt in to receive reporting results. The real-time or near real-time data can also be aggregated at larger (e.g., regional) level to report to other institutions and commercial organizations (hospitals, schools, pharmaceutical manufacturers, etc.). Additionally, upon entering a customs area other sensing devices scan a passport and take a photo of the traveler. An IR camera can check for elevated temperature and notify the traveler and/or customs personnel.

In a further example, athletes wear a fitness band and temperature detectors when on the field. The team has a group health account which allows identified people to receive alerts based upon certain conditions and to share certain metrics. Sensors can detect abnormally high body temperature (indicative of possible heat stroke) and send alert to coach. Sensors can also detect abnormal heart rhythm and send alert to coach. Coach can pull (near) real time stats on players. Athletes can also wear other sensors, for example, embedded in a helmet or mouth piece that can sense when an athlete has suffered an impact with the potential to cause a concussion.

Fitness bands can be used to monitor post-surgical activities of patients to determine if a patient is recovering as anticipated.

At risk or elderly individuals can be monitored on a continuous basis with reporting of statistics to doctors and emergency services for quick attention. Within a medical facility, remote monitoring provides increased freedom of movement without being tethered to a monitor. At home, remote monitoring can help individuals maintain independence and autonomy while remaining secure.

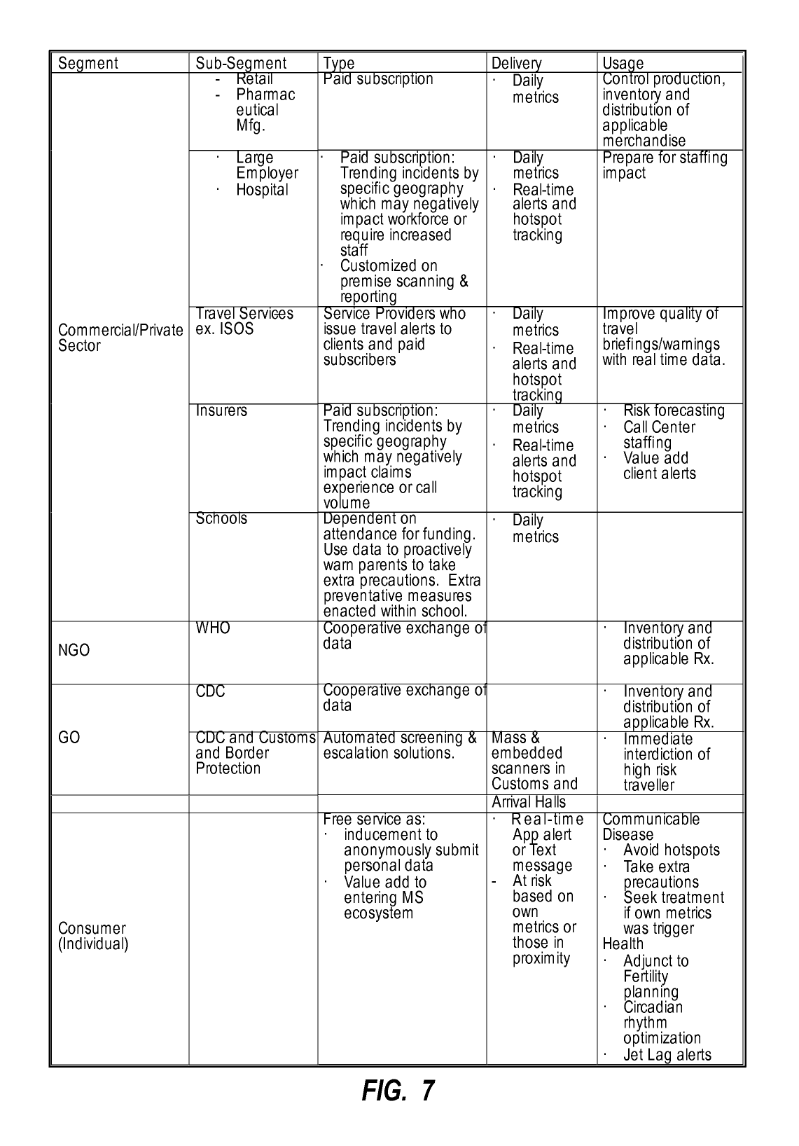

FIG. 7 illustrates an example table 700 of market segments and usage types. Within table 700, segments are further divided into sub-segments. Table 700 indicates access types useful to particular sub-segments for accessing health related events and/or values for physical metrics. Table 700 also indicates delivery mechanisms useful to particular sub-segments for accessing health related events and/or values for physical metrics. Table 700 also indicates how health related events and/or values for physical metrics are useful to the particular sub-segments.

Accordingly, the described aspects facilitate personal, regional and global healthcare (and other scenarios) driven by spatio-temporal streams of dynamically collected physical metric data (body metric data and environment metric data) from a variety of sensing devices with varied capabilities. Collected physical metric data can be anonymized or personalized based at least in part on data source. Pattern analysis can be used to report at different levels (e.g., personal or commercial, localized or global) and return relevant contextual driven results, including potential healthcare related events or other events relating to the study of changes that occur in large groups of people over a period of time (e.g., relating to demography).

In general, the described aspects are advantageous for distilling health related events from potentially large and diverse amounts of sensed physical metric data. The described aspects can also be used to identify (predict) developing health related events in near real-time or essentially in real-time. Health related events along with other relevant data can be rendered in a visual arrangement of content at a user interface. The visual arrangement provides a meaningful presentation of the health related event and other relevant data to a viewing individual.

In some aspects, a system includes one or more processors, a plurality sensing devices, a database of physical metric data, and one or more computer storage devices. The plurality of sensing devise include a plurality of differ types of sensing devices. Each different type of sensing device is configured to sense values for one or more physical metrics in accordance with a specified timing and with a designated degree of accuracy. The one or more physical metrics include one or more of: body metrics and environmental metrics

The database of physical metric data stores sensed values for physical metrics, the sensed values having been sensed by the plurality of sensing devices. The physical metric data is stored in a plurality of database entries in the database of physical metric data. Each database entry includes a value for a physical metric, geo-spatial data, temporal data, and a device identifier. For each database entry, the device identifier identifies a sensing device that collected the value for the physical metric and indicates the designate degree of accuracy for the sensing device.

The one or more computer storage devices having stored thereon computer-executable instructions representing one or more modules for identifying a health related event. The one or more modules are configured to access a request for a health related determination. The one or more modules are also configured to identify a sub-plurality of database entries, from among the plurality of entry database entries, as relevant to the request. Each of the sub-plurality of entry database entries is identified as relevant based on one or more of: the physical metric data, the geo-spatial data, the temporal data, and the device identifier included in the database entry.

The one or more modules are also configured to: aggregate values included in sub-plurality of database entries in into an aggregated data set in accordance with the request, analyze the aggregated data set to identify a health related event, and indicate the identified health related event in response to the request. The one or more modules are further configured to render the health related event along with the other relevant and/or representative data and content in a visual arrangement of content at a user interface (e.g., a Graphical User Interface (GUI)). The visual arrangement of content visually and meaningfully conveys circumstances of the health related event for the aggregated data set.

In another aspect, a computer system performs a method for identifying a health related event. The computer system can be communicatively coupled to a database of physical metric data. The database stores values for one or more physical metrics, including one or more of: body metrics and environmental metrics. The physical metric data is stored in a plurality of database entries. Each database entry includes a value for a physical metric, geo-spatial data, temporal data, and a device identifier. The device identifier identifies a sensing device that collected the value for the physical metric, the physical metric data related to a plurality of individuals, the physical metric data collected using one or more corresponding sensing devices configured to sense one or more different physical metrics. The physical metric data is automatically collected from the one or more corresponding sensing devices in accordance with specified timing

A request for a health related determination is accessed. A sub-plurality of data entries is identified, from among the plurality of entry database entries in a database of physical metric data, as relevant to the request. The database stores values for one or more physical metrics, including one or more of: body metrics and environmental metrics. The physical metric data is stored in a plurality of database entries. Each database entry includes a value for a physical metric, geo-spatial data, temporal data, and a device identifier. The device identifier identifies a sensing device that collected the values for the physical metric. The physical metric data collected from one or more corresponding sensing devices in accordance with specified timing.

Each of the sub-plurality of entry database entries is identified as relevant based on one or more of: the physical metric data, the geo-spatial data, the temporal data, and the device identifier included in the database entry. Values included in sub-plurality of database entries are aggregated in into an aggregated data set in accordance with the request. The aggregated data set is analyzed to identify a health related event. The identified health related event is indicated in response to the request. The health related event is rendered along with the other relevant and/or representative data and content in a visual arrangement of content at a user interface (e.g., a Graphical User Interface (GUI)). The visual arrangement of content visually and meaningfully conveys circumstances of the health related event for the aggregated data set.

In another aspect, a computer program product for use at a computer system includes one or more computer storage devices having stored thereon computer-executable instructions that, when executed at a processor, cause the computer system to implement a method for identifying a health related event. The computer program product includes computer-executable instructions that, when executed, cause the computer system to access a request for a health related determination.

The computer program product includes computer-executable instructions that, when executed, cause the computer system to identify a sub-plurality of data entries, from among the plurality of entry database entries in a database of physical metric data, as relevant to the request. The database stores values for one or more physical metrics, including one or more of: body metrics and environmental metrics. The physical metric data is stored in a plurality of database entries. Each database entry includes a value for a physical metric, geo-spatial data, temporal data, and a device identifier. The device identifier identifies a sensing device that collected the values for the physical metric. The physical metric data collected from one or more corresponding sensing devices in accordance with specified timing. Each of the sub-plurality of entry database entries is identified as relevant based on one or more of: the physical metric data, the geo-spatial data, the temporal data, and the device identifier included in the database entry.

The computer program product includes computer-executable instructions that, when executed, cause the computer system to aggregate values included in sub-plurality of database entries in into an aggregated data set in accordance with the request, analyze the aggregated data set to identify a health related event; and, indicate the identified health related event in response to the request.

The computer program product includes computer-executable instructions that, when executed, cause the computer system to render the health related event along with the other relevant and/or representative data and content in a visual arrangement of content at a user interface (e.g., a Graphical User Interface (GUI)). The visual arrangement of content visually and meaningfully conveys circumstances of the health related event for the aggregated data set.

The described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A method comprising:
accessing a request for a health related determination;
identifying a sub-plurality of database entries, from among the plurality of entry database entries, as relevant to the request, each of the a sub-plurality of entry database entries identified as relevant based on one or more of: the physical metric data, the geo-spatial data, the temporal data, and the device identifier included in the database entry;
aggregating values included in sub-plurality of database entries in into an aggregated data set in accordance with the request;
analyzing the aggregated data set to identify a health related event; and
indicating the identified health related event in response to the request.

2. The method of claim 1, wherein identifying a sub-plurality of database entries comprises identifying a sub-plurality of database entries having a device identifier identifying a device with accuracy satisfying a threshold associated with the request.

3. The method of claim 1, wherein identifying a sub-plurality of database entries comprises identifying a sub-plurality of database entries having geo-spatial data indicative of a value being collected at a location associated with the request.

4. The method of claim 1, wherein identifying a sub-plurality of database entries comprises identifying a sub-plurality of database entries having temporal data indicative of a value being collected within a time period associated with the request.

5. The method of claim 1, wherein identifying a sub-plurality of database entries comprises identifying a sub-plurality of database entries having environmental data indicative of a value being collected within a time period associated with the request

6. The method of claim 1, wherein aggregating values included in sub-plurality of database entries comprises aggregating values for body metrics into an aggregated data set.

7. The method of claim 6, wherein analyzing the aggregated data set to identify a health related event comprises predicting occurrence of a health related event or endpoint by determining that a specified number of values for body metrics satisfy a threshold.

8. The method of claim 6, wherein aggregating values for body metrics into an aggregated data set comprises aggregating values for body temperature and values for at least one other body metric into an aggregated data set.

9. The method of claim 1, wherein aggregating values included in sub-plurality of database entries into an aggregated data set in accordance with the request comprises statistically weighting at least one value to account for accuracy of a device used to measure at least one value.

10. The method of claim 1, wherein analyzing the aggregated data set to identify a health related event comprises analyzing the aggregated data to predict a health related event for one or more individuals.

11. The method of claim 1, wherein analyzing the aggregated data set to identify a health related event comprises analyzing the aggregated data to predict a health related event occurring at a location.

12. A computer program product for implementing a method for identifying a health related event, the computer program product comprising one or more computer storage devices having stored thereon computer-executable instructions that, when executed at a processor, cause the computer system to perform the method, including the following:
access a request for a health related determination;
identify a sub-plurality of database entries, from among the plurality of entry database entries, as relevant to the request, each of the a sub-plurality of entry database entries identified as relevant based on one or more of: the physical metric data, the geo-spatial data, the temporal data, and the device identifier included in the database entry;
aggregate values included in sub-plurality of database entries in into an aggregated data set in accordance with the request;
analyze the aggregated data set to identify a health related event; and
indicate the identified health related event in response to the request.

13. The computer program product of claim 12, wherein computer-executable instructions that, when executed, cause the computer system to identify a sub-plurality of database entries comprise computer-executable instructions that, when executed, cause the computer system to identify a sub-plurality of database entries having a device identifier identifying a device with accuracy satisfying a threshold associated with the request.

14. The computer program product of claim 12, wherein computer-executable instructions that, when executed, cause the computer system to aggregate values included in sub-plurality of database comprise computer-executable instructions that, when executed, cause the computer system aggregate values for body metrics into an aggregated data set; and
wherein computer-executable instructions that, when executed, cause the computer system to analyze the aggregated data set to identify a health related event comprise computer-executable instructions that, when executed, cause the computer system to predict occurrence of a disease by determining that a specified number of values for body metrics satisfy a threshold.

15. The computer program product of claim 12, wherein computer-executable instructions that, when executed, cause the computer system to aggregate values included in sub-plurality of database entries into an aggregated data set in accordance with the request comprise computer-executable instructions that, when executed, cause the computer system to statistically weight at least one value to account for accuracy of a device used to measure at least one value.

16. The computer program product of claim 12, wherein computer-executable instructions that, when executed, cause the computer system to analyze the aggregated data set to identify a health related event comprise computer-executable instructions that, when executed, cause the computer system to analyze the aggregated data to identify a health related event for one or more individuals.

17. The computer program product of claim 12, wherein computer-executable instructions that, when executed, cause the computer system to analyze the aggregated data set to identify a health related event comprise computer-executable instructions that, when executed, cause the computer system to analyze the aggregated data to predict a health related event occurring at a location.

18. A system, the system comprising:
one or more processors;
a plurality of sensing devices, the plurality of sensing devices including a plurality of different types of sensing devices, each different type of sensing device configured to sense values for one or more physical metrics, each sensing device configured to sense values for physical metrics in accordance with a specified timing and with a designated degree of accuracy, the one or more physical metrics including one or more of: body metrics and environmental metrics;
a database of physical metric data, the database storing sensed values for physical metrics, the sensed values having been sensed by the plurality of sensing devices, the physical metric data stored in a plurality of database entries, each database entry including a value for a physical metric, geo-spatial data, temporal data, and a device identifier, the device identifier identifying a sensing device that collected the value for the physical metric and indicating the designate degree of accuracy for the sensing device; and
one or more computer storage devices having stored thereon computer-executable instructions representing one or more modules for identifying a health related event, the one or more modules configured to:
access a request for a health related determination;
identify a sub-plurality of database entries, from among the plurality of entry database entries, as relevant to the request, each of the a sub-plurality of entry database entries identified as relevant based on one or more of: the physical metric data, the geo-spatial data, the temporal data, and the device identifier included in the database entry;
aggregate values included in sub-plurality of database entries in into an aggregated data set in accordance with the request;
analyze the aggregated data set to identify a health related event; and
indicate the identified health related event in response to the request.

19. The system of claim 18, wherein the database of physical metric data stores physical metric data for a specified domain and wherein the database of physical metric data aggregates physical metric data from other databases in one or more sub-domains of the domain.

20. The system of claim 18, wherein the one or more modules being configured to aggregate values included in sub-plurality of database entries into an aggregated data set in accordance with the request comprise the one or more modules being configured to statistically weight at least one value to account for accuracy of a device used to measure at least one value.
